(19) United States
(12) Patent Application Publication
(10) Pub. No.: US 2009/0194341 A1
(43) Pub. Date: Aug. 6, 2009

(54) METHOD AND DEVICE FOR OPERATING A RESISTIVE TOUCH INPUT COMPONENT AS A PROXIMITY SENSOR

(75) Inventor: Jari Nousiainen, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 12/026,165

(22) Filed: Feb. 5, 2008

(51) Int. Cl. G06F 3/041; G08C 21/00

(52) U.S. Cl. 178/18.01; 178/20.01

(57) ABSTRACT

A device is provided which includes a resistive touch input component. The resistive touch input component may operate as a proximity sensor and may include upper and lower conductive layers. The upper conductive layer may be in a higher impedence state than the lower conductive layer. A method for controlling a resistive touch input component is also provided in which at least a first terminal of a device is provided for connecting the upper conductive layer in a high impedence state, and in which at least one second terminal is provided for connecting a lower conductive layer in a state capable of operating the touch input component. Corresponding computer program products and devices are also provided.

### BACKGROUND OF THE INVENTION

Presently, there are different proximity sensors available on the market. However, there are only a few proximity sensors available which are capable of being used in connection with small portable devices.

In the US patent application US2007085157 it is disclosed to use a combined proximity sensor/ambient light sensor for use in a mobile device.

From European patent EP 0756733 B1 a low-cost resistive tablet with touch and stylus functionality is known that uses a resistive tablet having a DC driver for resistive detection and the disclosed device also has an AC driver for capacitive finger detection.

Touch devices are becoming more common and many of these devices use proximity sensors to achieve operations such as turning on/off the display during an incoming phone call.

A resistive touch screen panel is composed of several layers. The most common are composed of two thin metallic electrically conductive/resistive layers separated by a thin space. When some object touches this kind of touch panel, the layers are connected at a certain point; the panel then electrically acts similar to two voltage dividers having connected outputs. This causes a change in the electrical current which is detected as a touch event and sent to the controller for processing. When sensing a press force, it is useful to add a resistor dependent on force in this model between the dividers.

A resistive touch panel output may consist of between two, four and eight wires or more wires. The positions of the conductive contacts in resistive layers differ depending on how many wires are used. When four wires are used, the contacts are placed on the left, right, top, and bottom sides. When five wires are used, the contacts are placed in the corners and on one plate. 4 wire resistive panels can estimate the area (and hence the pressure) of a touch based on calculations from the resistances.

It is desired to have as simple and cheap solution for providing touch screen functionality and a proximity sensor functionality to a preferably mobile device.

It is also desirable to have a simple solution for providing an electronic device having a touch screen display with a proximity sensor located in the area of a display of the device.

### SUMMARY OF THE INVENTION

According to an embodiment of the present invention a device is provided comprising a resistive touch input component. Said resistive touch input component comprises an upper conductive layer and a lower conductive layer, wherein said upper conductive layer is in a higher impedance state than said lower conductive layer.

The upper conductive layer is directed towards a user of a resistive touch input component (e.g. a touch pad/touch screen). The lower conductive layer is directed to the screen or the device (or located at a position opposite to the user with respect to the upper layer) of a resistive touch input component. The device is configured that said upper conductive layer is in a higher impedance state than said lower conductive layer.

In an example embodiment of the present invention the device further comprises at least one first terminal connected to said upper conductive layer of said resistive touch input component and, at least one second terminal connected to said lower conductive layer of said resistive touch input component, wherein said device is configured to provide said at least one first terminal in a high impedance state with respect to said second terminals. This embodiment may be considered or embodied as a resistive touch input component connected to the terminals of a resistive touch input component controller that is providing said higher impedance state.

According to an embodiment of the present invention a device for a resistive touch input component is provided. The device comprises at least one first terminal for connecting an upper conductive layer (directed towards a user) of a resistive touch input component (e.g. a touch pad/touch screen). The device also comprises at least one second terminal for connecting a lower conductive layer (directed to the screen or the device) of a resistive touch input component. The device is configured to provide said at least one first terminal in a high impedance state with respect to said second terminals.

The device may be implemented as a controller for a touch screen or a touchpad.

That is, in contrast to the state of the art embodiments, of touch input components, the upper layer is not provided with a defined and fixed voltage potential. In embodiments of the present invention the device is configured to provide a floating voltage to the upper layer of a resistive touch input component.

A two wire touch input component may be embodied as a linear touch line that may be used for inputting a volume into an electric audio device.

This aspect of the present invention allows it to use the upper layer of a resistive touch input component also for additional tasks such as e.g. a proximity sensor function.

In an example embodiment of the present invention the device further comprises a resistive touch input component, having at least one upper conductive layer and at least one lower conductive layer, wherein at least one first terminal is connected to an upper conductive layer of said resistive touch input component and, wherein at least one second terminal is connected to a lower conductive layer of said resistive touch input component. This embodiment may be considered as a kind of touch device implementation of the device disclosed above. This embodiment may be directed to a touch pad module in which a device or a controller according to the above embodiment is built in. It may also be noted that this embodiment may be implemented with two more or less independent components for determining proximity and or a touch input.

In an example embodiment of the present invention said device is further configured to determine a change of the impedance of at least one of said at least one first terminal. In an example embodiment of the present invention said device is further configured to determine a change of the impedance of a wire, a lead or an electronic component or an upper layer of a touch input component connected to at least one of said at least one first terminal.

It may be noted that it is also possible to operate the first terminal of the device only for a part of the time in a high impedance state. This would lead to an example embodiment in which the two layers of the touch component (i.e. the touch screen or the touchpad) are operated alternatively in a floating and in a non-floating condition. This embodiment represents a multiplex touch input component and proximity sensor operation (of a connected touch input component) by the device.

In another example embodiment of the present invention the device is further configured to provide a changing voltage to (at least one of) said at least one first terminal, and to determine said change on the impedance of said at least one first terminal by determining a change of changing current caused by said changing voltage applied to at least one of said at least one first terminal.

This example embodiment serves to operate at least the upper layer of a touch component as a contact for a capacitive proximity sensor. The wording “changing voltage” has been selected to avoid a strict restriction to alternating voltages, sinusoidal alternating currents, single frequency alternating currents and the like. With the selected wording it should also be possible to use the upper layer of a touch component with a DC current with a superimposed smaller AC component, in a way that the voltage of the upper conductive layer (i.e. the first terminal) never changes its polarity.

In another example embodiment of the present invention said device is further configured to determine a change of the impedance of at least one second terminal. This may be embodied by applying a changing voltage applied to the second terminal as in the case suggested for the first terminal. It is contemplated to use a changing current simultaneously at both the first and the second terminals, synchronously to avoid sensing the capacity of the touch component (i.e. the capacity between the upper and the lower layer of the touch input component).

Changes of impedances of a first and/or second terminal (or of a circuitry or component connected to a terminal) may be performed by determining a resonance frequency of said circuitry/component. Resonance frequencies may be determined by applying a wobbling AC and determining the voltage/current phase difference. It may also be possible to determine the impedance by determining the power consumption of a circuit at different input frequencies.

In yet another example embodiment of the present invention said device is further configured to provide a changing voltage to said at least one second terminal, and to determine said change on the impedance of said at least one first terminal by determining a change of changing current caused by said changing voltage applied to said at least one second terminal.

This embodiment may be considered as an embodiment in which the sensed current is used to determine the impedance (and a change of impedances) of the lower layer, too. It may be expected that the highest impedance can be observed if and when there is no conductor in the vicinity of the upper layer of a connected touch component connected to said device.

In another example embodiment of the present invention the device is further provided with a proximity output, wherein said device is configured to output a proximity signal if and when a change of the impedance has been detected.

This embodiment is especially advantageous if the device is not implemented as an integral part of a universal central processing unit. This may be embodied as a device to be used in connection with displaying data on a remote display while the data processing is performed on a different element (not being part of the device or controller) of an electronic device. This embodiment may be used e.g. when using for example a touch screen with an integrated device having an extra terminal for outputting a proximity signal, to enable the device to change e.g. the setting of a display or other components (such as e.g. an audio output) in accordance with a received proximity signal.

In another example embodiment of the present invention the device is provided with a storage to store a “no-proximity value” for said impedance. In this embodiment said proximity signal may be outputted if and when a difference between said stored “no proximity value” impedance and said determined impedance exceeds a predetermined (and stored) threshold.

This embodiment allows a simple and fast calibration of the proximity functionality of the device, as it is possible to store one (or more) value(s) for defined proximity and non-proximity situations allowing the system to “learn” which detected impedance values are to be used to output a signal indicating a proximity event. Pre-stored impedance data may also be used to define different distances of proximity. Though only a single proximity value may be stored, it is also contemplated to store a number of different stored values enabling the device to output different values of proximity each for different proximity situations.

In another example embodiment of the present invention, said device is further configured to stop providing said direct current voltage to said (at least one first and) second terminals when a difference between said stored “no proximity value” impedance and said determined impedance does not exceed a predetermined threshold.

That is, in order to save energy the voltage difference usually provided between the upper and the lower conductive (or resistive) layer of a resistive touch component may only be activated if and when proximity of an expected conductive stylus was detected. Even though it is not explicitly stated, the device may be configured to determine from the electrical voltage between the first and second terminals (i.e. received from the upper and lower conductive layer of a touch component) a position at which both layers are in contact. The device may also be configured for outputting a signal indicating the position of a touch input on the touch device. It may also be noted that the device may be configured to output a signal indicating (or being related) to a pressure exerted on said touch component.

In yet another example embodiment of the present invention the device is further configured to stop applying said changing voltage if a direct current is detected between said (at least one) first and second terminals. This example embodiment pertains to a device that may deactivate the proximity sensor functionality (or the impedance measurement process) in case a touch input is detected. This embodiment may serve to save energy by deactivating the proximity detection if and when a touch input is detected, as it may be expected that there has to be a kind of proximity event (or signal) in case a touch input is detected, i.e. there is an object actually in contact with the touch component.

In still another example embodiment of the present invention the device further comprises a touch input component (such as a touch pad/touch screen). That is, this embodiment represents a touch input component with an integrated device for operating the upper layer of the touch component as a capacitive proximity sensor. In this embodiment the device is also configured to also operate the touch input functionality (including an input position output) to the touch screen module. It is also envisaged to also include a frame buffer and a display driver module in a touch screen device/module according to a slightly different embodiment also including the functionality of a display module.

In yet another example embodiment of the present invention the device is further provided with an electronic device comprising a touch input component and at least a processing unit. This embodiment represents an electronic device capable of receiving touch input (process this touch input) and recognizing proximity of objects in the vicinity of the touch component.

In another example embodiment of the present invention the electronic device comprises a PDA, a handheld gaming device, a camera, a GPS or navigation device, a media player or a cellular telephone. This embodiment pertains to a mobile electronic devices, (such as e.g. cellular phones) provided with the capability to be controlled via an input by a direct contact to the touch component and by proximity of an object close to the touch input component. It may be noted that it is also possible to provide the electronic device of this example embodiment with additional proximity sensors, too. However, in these embodiments it is expected that the additional proximity sensors are arranged to cover other/additional areas of the electronic device.

According to another example embodiment of the present invention a method for operating a device for a resistive touch input component (such as a touch pad / touch screen) is provided. The method may comprise: providing at least one first terminal of said device for connecting an upper conductive layer of a resistive touch input component in a high impedance state and providing each of at least one second terminal for connecting a lower conductive layer of a resistive touch input component in a state capable of operating said touch input component.

That is, the present embodiment may be considered in an embodiment as a method in which the terminal for the upper layer of a resistive touch input device (e.g. a touch screen or a touchpad) is controlled permanently or periodically in a way to determine changes in the capacitance or reactance to use the upper layer as a sensor area of a proximity sensor. To enable a detection of changes in the AC resistance the terminal(s) for the upper layer of the touch component are placed in a high impedance state. In case the upper layer would be in a low impedance state it would be difficult to determine the proximity of an object (which is expected to cause a drop in the impedance). As a drop of a (AC-) resistance can be detected more easily if and when the drop occurs from a high (AC-) resistance, the method uses this fact by setting the upper layer of a touch component to a high impedance state.

In an example embodiment the method further comprises providing a direct voltage at said at least one second terminal (to a lower conductive layer of a touch input component), and if at least one direct current between said at least one first and second terminals is detected: determining a position of a touch input on a touch input component connected. The method may further comprise outputting said determined position of a touch input to a second component such as processing unit or a user input unit.

In yet another example embodiment of the present invention, the method further comprises: sensing the impedance of at least one first terminal, and if a change in the impedance of at least one first terminal is sensed: outputting a proximity signal. The outputted proximity signal may be a “proximity detected”, a “no proximity detected” or a “change in proximity detected” signal. It is also envisaged to continuously output said signal until a next change of an impedance (having a different sign) is detected.

In still another example embodiment said sensing the impedance of at least one first terminal comprises providing a changing voltage to at least one first terminal, and determining a change of changing current caused by said changing voltage applied to said at least one first terminal. This embodiment pertains to a current or power based impedance or proximity measurement. It may also be possible to determine the phase difference between the changing voltage and said changing current to determine the impedance state (or a proximity state) of the upper layer of a touch input component.

In another example embodiment the method further comprises sensing the impedance of at least one second terminal. This embodiment uses a combined proximity measurement. In this embodiment the impedance of the lower conductive layer of a resistive touch input component may be sensed to determine if a proximity signal of the upper conductive layer of a resistive touch input component is caused by proximity or by other origins. When sensing a change of the impedance of the lower conductive layer of a touch input component it may be expected that a similar change in the upper layer is caused by a technical fault, but not by a proximity event. This is so, as the upper conductive layer should completely shield any electric fields from the lower conductive layer of the resistive touch input component connected.

In another example embodiment of the present invention said sensing the impedance of at least one second terminal comprises providing a changing voltage to at least one second terminal and determining a change of changing current caused by said changing voltage applied to said at least one second terminal. This embodiment uses the changing voltage as a guideline for assessing the change of (the changing) current, wherein a change in the impedance is determined by a difference between an expected and a sensed changing current at (at least one of) the first terminal(s) of the device. In a simple embodiment this may be implemented by an applied sinusoidal voltage, and sensing the amplitude and/or the phase difference of an induced sinusoidal current at said (at least one) first terminal (when a touch input component is connected to said at least one first terminal).

In yet another example embodiment the method further comprises sensing and storing a “no proximity” impedance value, and outputting said proximity signal if and when a difference between said stored “no proximity” impedance value and said determined impedance exceeds a predetermined threshold. It is expected that the “no proximity impedance value” represents the highest impedance that may be sensed. That is, it is expected that in any case of proximity the impedance value sensed is reduced with respect to the “no-proximity impedance value”.

In still another example embodiment of the present invention the method further comprises stop providing said direct current voltage to said (at least one first and) second terminals when a difference between said stored “no proximity value” impedance and said determined impedance does not exceed a predetermined threshold. This embodiment pertains to a situation for saving energy needed for operating the touch input component in case no proximity is detected. This embodiment is based on the assumption that a touch input may only occur when at least a pen or a finger (or another object) of a user touches the surface of the touch input component connected to the device. However, this requires that an object is in close proximity to the touch input component. If no object can be detected, in the proximity, there can be no touch input, and therefore it is not necessary to provide any energy to operate a connected touch input component in a touch input mode. It is also possible to completely deactivate this part of the device provided for detecting and locating a touch input on said touch input component, if no proximity is detected. This may lead to a small contribution in reducing the power consumption of a battery operated mobile electronic device. It may also be envisaged to activate both components only upon a key input for preventing continuous operation of the device if the mobile electronic device using the present invention is carried e.g. in a pocket.

In another example embodiment of the present invention the method further comprises stop applying said changing voltage if a direct current is detected between said at least one first and second terminals. This embodiment pertains to the “inverted situation” of the preceding embodiment. In the present example embodiment the detection of a touch input on a touch input component connected to said device/controller requires that there is at least an object in touch with (and thus in close proximity to) the touch input component. As a touch input is to be expected to be only possible if an object actually touches the touch input component, it is not necessary to waste electric energy for operating the (touch input component and the device as a) proximity sensor.

It is also possible to measure the presence of a proximity while a touch input is detected (i.e. the at least two resistive layers are connected to each other by a pressure exerted on the touch input component). This may be used to notify the user not to touch the screen/touch input component when using e.g. a (e.g. non conductive) stylus for touch input (the stylus may be non conductive to prevent a proximity signal caused by the stylus). This may be used to prevent wrong input detection caused by two touch input, i.e., electric connections between the two resistive layers at two different points.

In yet another example embodiment of the present invention the method further comprises changing the settings of said electronic device in dependence if the device for a resistive touch input component outputs a proximity signal (or not). This embodiment pertains to the situation in which the proximity signal is actually used to change the settings of a mobile device according to a detected proximity (or a detected change in the impedance of the upper layer of a touch input component). The specific use of a detected proximity signal may depend on the application of the electronic device the present invention is built-in. In case of e.g. a mobile telephone the proximity signal may be used to deactivate a touch input component (if e.g. a detected proximity indicates a proximity of a flat surface covering object), to deactivate a hands-free operation of a telephone component.

According to another aspect of the present invention, a computer program product for carrying out the method of the preceding description is provided, which comprises program code means for performing all of the steps of the preceding methods when said program is run on a device, a computer or a network device.

According to yet another aspect of the invention, a computer program product is provided comprising program code means stored on a computer readable medium for carrying out the methods of the preceding description, when said program product is run on a device, a computer or a network device.

According to still another aspect of the present invention a device, is provided comprising a resistive touch input means, having an upper conductive means and a lower conductive means, and wherein said upper conductive means is in a higher impedance state than said lower conductive means. This may be considered as pertaining to the touch input means aspect of the present invention.

According to still another aspect of the present invention a device for a resistive touch input component is provided. Said device for operating a resistive touch input component, comprises at least one first means for connecting at least one upper conductive means of a resistive touch input component and at least one second means for connecting at least one lower conductive means of a resistive touch input component, wherein said device comprises means for providing said at least one first means for connecting in a high impedance state with respect to said second means for connecting. This aspect may be considered as pertaining to the controller of a touch input means aspect of the present invention.

### BRIEF DESCRIPTION OF THE DRAWINGS

In the following, the invention will be described in detail by referring to the enclosed drawings in which:

FIG. 1 is an example embodiment for the operation of a resistive touch input component in a touch detection mode,

FIG. 2 is an example embodiment of the operation of the upper layer of a resistive touch input component in proximity detection mode,

FIG. 3 is an example of an embodiment of a mobile electronic device provided with a touch input component capable of being operated in a proximity detection mode,

FIG. 4 is an example of a flowchart for operating an upper layer of a resistive touch input device in a proximity detection mode,

FIGS. 5A and 5B show example embodiments of resistive touch input components,

FIG. 6 is an example embodiment a resistive touch input component having a number of upper layers that may be used for proximity detection,

FIG. 7 is an example of an embodiment touch input component capable of being operated in a proximity detection mode and in resistive touch input mode, and

FIG. 8 is an example of a flowchart for operating an upper layer of a resistive touch input device in a proximity detection mode.

### DETAILED DESCRIPTION

In the detailed description which follows, identical components have been given the same reference numerals, regardless of whether they are shown in different embodiments of the present invention. In order to clearly and concisely illustrate the present invention, the drawings may not necessarily be to scale and certain features may be shown in somewhat schematic form.

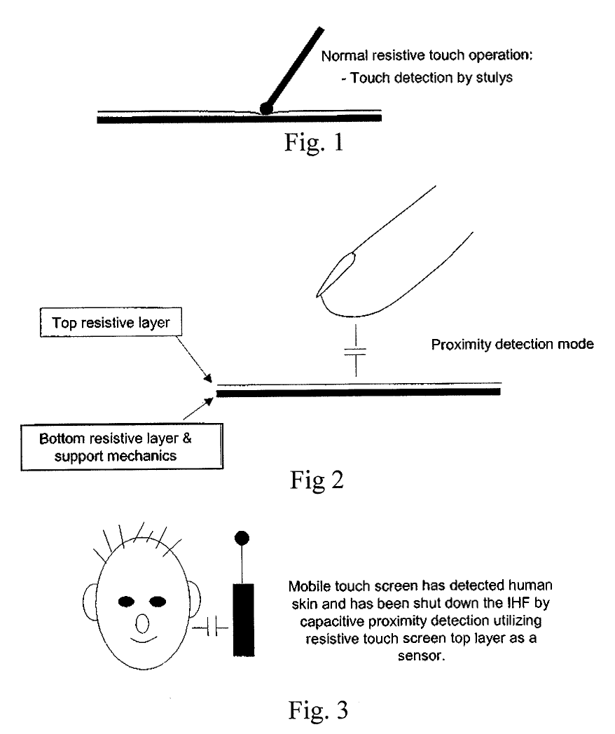

FIG. 1 depicts a resistive touch input component such as a touch pad or a touch screen. The touch input component has an upper layer and a bottom layer separated by (not depicted) spacer components. As used herein, upper and lower layers refer to a first outboard layer and a second inboard layer without regard to the overall orientation of the device which includes the touch input component. The stylus or pen exerting a force on the upper layer of the touch input device brings the upper conductive layer and the lower conductive layer of the touch input device in electrical (or galvanic) contact. By using a respective analyzing circuit, it is possible to determine the position of the place where the upper conductive layer and the lower conductive layer are in contact. This may be achieved e.g. in a linear touch input component by using a layer having a small internal resistance (or conductivity) and a second layer having a high internal resistance (or conductivity). In dependence of the position of the terminals of the layers, the resistance of the layers and the position of the place the layers are in contact a different overall resistance is sensed between the terminals of the upper and lower conductive layers. The sensed resistance is related to the point (position) on the touch input component the two layers are electrically in contact. In principle this may be used in analogy to the use of transducer potentiometers for e.g. loudness input in audio devices known in the art. When applying a more sophisticated approach, it is possible to use the same principle also for two-dimensional touch input components such as touch pads and touch screen devices.

The touch input component depicted in FIG. 1 is operated in a resistive touch input component in touch detection mode. This may be done by applying a direct voltage to electrodes located at (at least one corner or edge of) the lower and upper conductive layer. The top layer may be left at a floating potential. In case an electrical connection is made between the upper and the lower conductive layers of the touch input component, the potential of the upper layer is drawn to the potential of the point of the lower layer the upper layer is in contact with. Resistive touch input components have been recognized as very mature and usable component for having stylus and finger touch input for mobile devices.

FIG. 2 is an example embodiment of the operation of the upper layer of a resistive touch input component in proximity detection mode. In the proximity sensing mode a change of the capacitance of a layer or a surface can be determined by sensing the reactance or the impedance (or the resistance for alternating current) of the upper layer of the touch input component. The impedance changes with the capacitance/capacity of the upper layer of the touch input component. The capacity of the upper layer of the touch input component is related to the dielectric properties in the vicinity of the upper layer of the touch input component. If there is no object in the vicinity of the upper layer of the touch input component, the capacity of the upper layer of the touch input component (in the direction away from the upper layer), is the capacity of an empty space. In case a conductive object or an object having a higher dielectrical property than air or empty space is approaching the upper layer of the touch input component, the capacity of the upper layer of the touch input component increases and thus the impedance decreases.

This decrease of the impedance of the upper layer of the touch input component can be sensed by applying e.g. a constant AC voltage, and sensing the AC current caused by said AC voltage. In case the AC current increases, it may be expected that an object having a higher dielectric property or a higher conductivity (than air) is present in the proximity of the upper layer of the touch input component. This enables a simple and cheap implementation of a proximity sensor to devices being provided with resistive touch input components.

The use of finger/hand presence detectable capacitive sensors (i.e. proximity sensors) has been known for the use as touch keys and rotators (scroll-wheels) in mobile devices. These devices may also be used for other applications: Proximity sensors may recognize the presence of a finger or hand over some distance in air. This capability may be used for proximity sensing. The top layer of a resistive touch input component may act as one capacitive touch/proximity sensor if the resistive touch device leaves the top layer in a high impedance state. When using the top/upper layer of a touch input component as a proximity sensor, there are the following advantages: There is no need to provide any additional separate proximity sensor to detect proximity, face or hand presence. The upper layer of the touch input component may be used as a proximity sensor and can serve to shutdown high volume of internal speakers in hands free mode, change display illumination and control some other applications of the device having a touch input component.

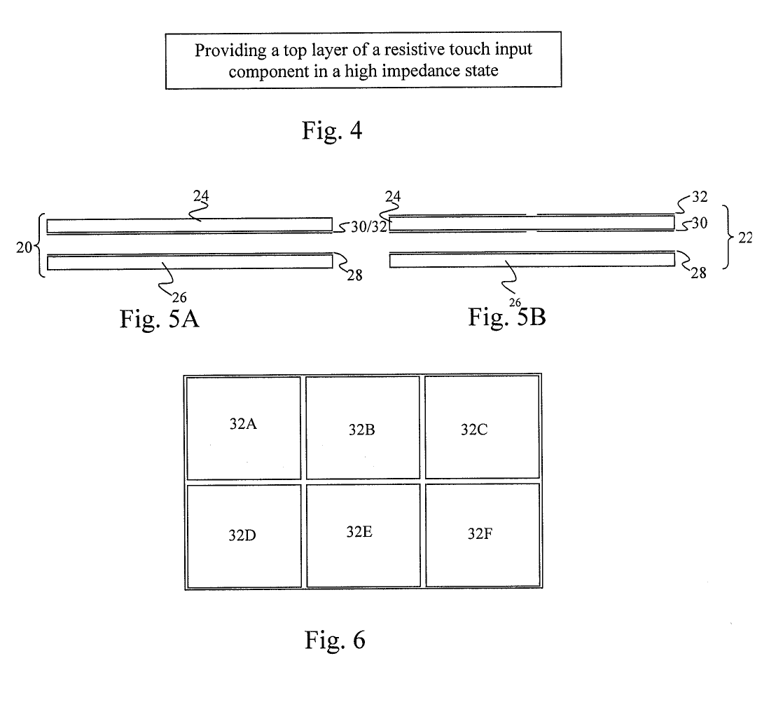

FIG. 3 is an example of an embodiment of a mobile electronic device provided with a touch input component capable of being operated in a proximity detection mode. In the depicted situation the electronic device is a mobile cellular phone that senses the proximity of the face of a user. The detected proximity of an object (here a cheek or a face of a user) may be used to restrict the sound pressure of a speaker to a maximum limit for preventing any hearing damage. The signal from the proximity sensor may also be used to switch on and off a display illumination—the display illumination may be switched off in case no proximity is detected, may be switched on in case a small proximity is detected (e.g. a stylus is used in the proximity of a touch screen) and may be switched off again in case a strong proximity is detected (if e.g. the user holds the device close to his face when making a telephone call).

The use of the upper layer of a touch input component has the additional advantage that a wide area and a wide angle of coverage is achieved and not only a small area and a narrow angle is provided in which a proximity may be detected. The wide area of the upper conductive layer of a resistive touch screen enables a very robust skin/ear/face detecting capability.

FIG. 4 is an example of a flowchart for operating an upper layer of a resistive touch input device in a proximity detection mode. The main step of the flowchart comprises providing (the terminal for connecting) the upper layer of a resistive touch input component in a high impedance state. In the high impedance state it is possible to apply a changing voltage to the (the terminal for connecting) the upper layer of a resistive touch input component. Subsequently, the current caused by said changing voltage (and the capacity of the upper layer of the touch input component) to flow may be sensed to determine if there is an object in the proximity of the upper layer of the touch input component. If e.g. a sinusoidal AC voltage is applied it may be sufficient to measure the AC current and/or a phase shift between the AC voltage and the AC current caused by the AC voltage. It may also be possible to just measure the amount of energy absorbed by the upper layer of the touch input component.

Using a device and a touch screen display (of an electronic device such as e.g. a mobile telephone) also as a proximity sensor reduces amount of components in the device as there is no need for separate proximity sensor. This allows use of proximity sensors also in low-cost touch screen devices. Although the use of the upper layer of a resistive touch input component may achieve the best possible proximity measurements when considering accuracy, the accuracy should be sufficient to allow the use of sensor in many purposes like turning on/off lights, hands-free, snooze alarm clock etc. Additionally, another advantage of the supposed invention resides in that the proximity sensor has a large sensing area (i.e. the whole surface of the touch input component).

FIGS. 5A and 5B show example embodiments of resistive touch input components.

FIG. 5A shows a cross section of a resistive touch field that may be used with embodiments of the present invention. The resistive touch input component may be used as a touch line, a touch field/pad or as part of a touch screen. The touch input component 22 of FIG. 5A comprises an upper supporting layer 26 and a lower supporting layer 26. Both supporting layers may be made of insulating material. It may however be also possible to use an integrated touch pad in which the supporting layers and the conductive layer are integrally made of e.g. a conductive material. The supporting layers are separated (e.g. by not depicted spacer elements). An upper conductive layer 30/32 is arranged on the lower surface of the upper supporting layer 24. A lower conductive layer 28 is arranged on the upper surface of the lower supporting layer 26.

In this embodiment the upper conductive layer 30/32 serves as upper conductive layer for the touch input device and may also be used as a sensor area for detecting proximity, if and when the upper conductive layer is provided in a high-impedance state.

In the embodiment of FIG. 5A only 2 conductive layers are depicted.

FIG. 5B shows an embodiment having a larger number of conductive layers. FIG. 5B shows a cross section of another resistive touch field that may be used with embodiments of the present invention. The resistive touch input component may be used as a touch line, a touch field/pad or as part of a touch screen. The touch input component 22 of FIG. 5B comprises an upper supporting layer 26 and a lower supporting layer 26. Both supporting layers may be made of insulating material. It may however be also possible to use an integrated touch pad in which the supporting layers and the conductive layer are integrally made of e.g. a conductive material. The supporting layers are separated (e.g. by not depicted spacer elements). Two outer upper conductive layers 32 are arranged on the upper surface of the upper supporting layer 24. Additionally, two inner upper conductive layers 30 are arranged on the lower surface of the upper supporting layer 24. One lower conductive layer 28 is arranged on the upper surface of the lower supporting layer 26.

The two outer upper conductive layers 32 may be used to detect proximity by measuring the capacitance (or the inductance) of the outer upper layers 32. The use of two different outer upper layers may serve to detect a location of proximity with respect to the touch input component. The use of more than one inner upper conductive layer 30 may serve to allow the device to save power, by activating only the upper inner layer for touch input detection, at which proximity has been detected before. The use of more than one inner upper conductive layer 30 may serve to allow the device to detect multipoint user inputs (as long as these inputs are detected in the areas of different inner upper conductive layers 30).

It is also possible to short circuit the outer and inner upper conductive layers 30/32 to use the touch/proximity sensor of FIG. 5B in a similar way than the one of FIG. 5A.

FIG. 6 is an example embodiment of a resistive touch input component having a number of (outer or inner) upper layers that may be used for proximity detection. This embodiment is provided to show that there are indeed applications in which more than just a single (inner or outer) upper or lower conductive layer may be used with the present invention.

It is apparent from FIG. 6 that proximity detection and touch input may be used in a single touch input component without an increased effort. It may be for example possible to control each of the conductive layers 32A to 32F in a multiplexed way using only a single controller for determining proximity/touch input for each of the conductive layers 32A to 32F in one after the other. It is also contemplated to use conductive layers 32A to 32F one after another for proximity detection, and to use only the conductive layers of the conductive layers 32A to 32F at which a proximity has been detected. It is also possible to use the device of FIGS. 5A as 6 to detect multi-point proximity and or multi-point user input (if the conductive layers 32A to 32F are embodied as outer/inner upper or lower conductive layers).

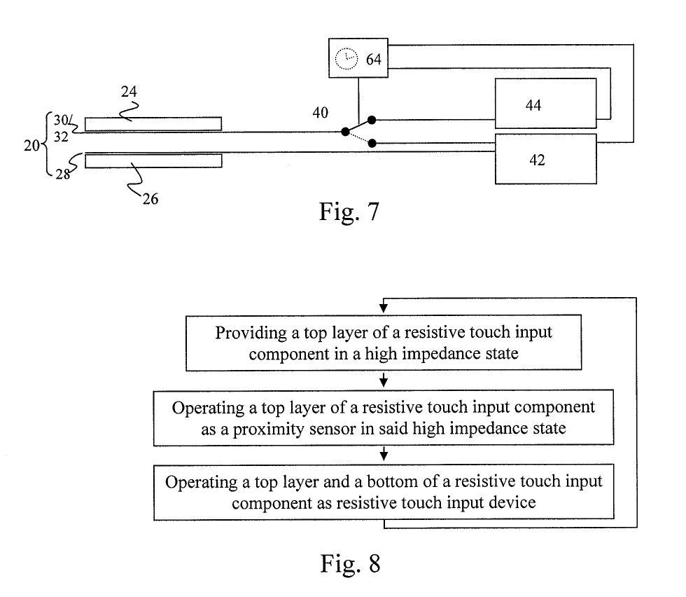

FIG. 7 is an example of an embodiment of a touch input component capable of being operated in a proximity detection mode and in a resistive touch input mode,

FIG. 7 depicts a touch pad having a construction such as depicted in FIG. 5A, that is connected to two different circuits. The circuit 44 is a proximity sensor circuit (that may be normally connected to the upper conductive layer 30/32). The proximity sensor circuit (or controller) 44 provides the upper conductive layer in a high impedance state. The proximity sensor circuit 44 may apply an AC-current to the upper conductive layer in a high impedance state, to determine the capacitance of the upper conductive layer 30/32 that may be determined by determining the reactance of the upper conductive layer 30/32.

A switch 40 is provided to alternatively connect a touch input circuit (or controller) 42 to the upper conductive layer 30/32 (and to the lower conductive layer 28). If the touch input circuit 42 is connected to the touch input component 20, the device may detect a touch input and a position of a touch input, as in the case of a conventional resistive touch input device.

The switch may be operated in a time controlled manner by a switch actuator 64 to implement an intermittent proximity/touch input detection. However it is also contemplated to use a loop controlled switch actuator 64, that operated the switch 40 in accordance with signals received from the proximity sensor circuit (/controller) 44 and/or from the touch input circuit (/controller) 42.

For the sake of clarity output terminals to other components of a (mobile) electronic device to inform a processing unit about a detected proximity or about a detected touch input have been omitted for the sake of clarity. However it is intended to have such terminals or connections to enable a device to use embodiments of the present invention for touch input and or proximity sensing.

FIG. 8 is an example of a flowchart for operating an upper layer of a resistive touch input device in a proximity detection mode.

For the sake of clarity an embodiment is depicted in which the touch input component is operated alternatingly as proximity sensor and as touch input device. The flowchart starts with providing a top layer of a resistive touch input component in a high impedance state. This is followed by operating a top layer of a resistive touch input component as a proximity sensor in said high impedance state. After (or while) the top layer of a resistive touch input component in a high impedance state, the top layer and a bottom layer of a resistive touch input component are operated as a resistive touch input device. Then the flowchart returns to the top to operate the touch input component alternatingly as a proximity sensor and as a touch input device.

It may be possible to implement embodiments of the present invention by using a capacitive proximity circuit in connection with a resistive touch pad device/controller together. When providing a circuit taking care that both measurement methods are not accessing simultaneously the touch pad/proximity sensor. This may be implemented by multiplexing the two devices/controllers to the device by using a (possibly time-controlled) switch. It may also be possible to use a number of switches to disconnect the first layer from the resistive touch device/controller and connect it to a capacitive proximity sensing device/circuit or controller.

In one embodiment a device for a resistive touch input component, can comprise, at least one first terminal component for connecting an upper conductive layer of a resistive touch input component and, at least one second terminal component for connecting a lower conductive layer of a resistive touch input component, and may be characterized in that said controller comprises means for providing said at least one first terminal component in a high impedance state with respect to said second terminal component.

In an embodiment according to one of the above embodiments the device may be characterized in that said controller is further configured to provide a direct voltage at said at least one second terminal component, and wherein said controller is further configured to determine a direct current between said at least one first and second terminal components, and wherein said controller further comprises means for determining a position of a touch input on a touch input component connected to said controller.

In an embodiment according to one of the above embodiments the device may be characterized in that said controller further comprises means for determining a change of the impedance of at least one first terminal component.

In an embodiment according to one of the above embodiments the device to be characterized in that said controller further comprises means to provide a changing voltage to said at least one first terminal component, and means to determine said change in the impedance of said at least one first terminal component by determining a change of changing current caused by said changing voltage applied to said at least one first terminal component.

In an embodiment according to one of the above embodiments said controller is further provided with means for determining a change of the impedance of at least one second terminal component.

In an embodiment according to one of the above embodiments the device may be characterized in that said controller is further provided with means for providing a changing voltage to said at least one second terminal component, and means for determining said change in the impedance of said at least one first terminal component by determining a change of changing current caused by said changing voltage applied to said at least one second terminal component.

In an embodiment according to one of the above embodiments the device may be characterized in that said controller is further provided with means for providing a proximity output, and wherein said means for providing a proximity output is configured for outputting a proximity signal if and when a change of the impedance has been detected by said means for detecting a change of the impedance.

In an embodiment according to one of the above embodiments the device may be characterized in that said controller further comprises a storage to store a “no proximity value” for said impedance, and wherein said controller further comprises a comparator for comparing a determined impedance and said stored “no proximity value” for said impedance, wherein said proximity signal is outputted if and when a difference between said stored “no proximity value” impedance and said determined impedance exceeds a predetermined threshold.

In an embodiment according to one of the above embodiments the device may be characterized in that said controller is further provided with means for stopping providing said direct current voltage to said (at least one first and) second terminal components when a difference between said stored “no proximity value” impedance and said determined impedance does not exceed said predetermined threshold.

In an embodiment according to one of the above embodiments the device may be characterized in that said controller is further provided with means for stopping applying said changing voltage if a direct current is detected between said at least one first and second terminal components.

In another embodiment (according to one of the above embodiments) the device may be embodied as a resistive touch input component comprising a controller device according to any one of the preceding embodiments.

In an embodiment the device or the resistive touch input component may be encompassed in an electronic device.

In an embodiment according to one of the above embodiment the electronic device may be a cellular telephone comprising a resistive touch input component or a device.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. A device, comprising,
a resistive touch input component,
wherein said resistive touch input component comprises an upper conductive layer and a lower conductive layer, and
said upper conductive layer is in a higher impedance state than said lower conductive layer.

2. A device according to claim 1, comprising,
at least one first terminal connected to said upper conductive layer of said resistive touch input component and,
at least one second terminal connected to said lower conductive layer of said resistive touch input component,
wherein said device is configured to provide said at least one first terminal in a high impedance state with respect to said second terminals.

3. A device, comprising,
at least one first terminal for connecting an upper conductive layer of said resistive touch input component and,
at least one second terminal for connecting a lower conductive layer of said resistive touch input component,
wherein said device is configured to provide said at least one first terminal in a high impedance state with respect to said second terminals.

4. The device of claim 3, further comprising,
a resistive touch input component, having at least one upper conductive layer and at least one lower conductive layer,
wherein at least one first terminal is connected to an upper conductive layer of said resistive touch input component and,
wherein at least one second terminal is connected to a lower conductive layer of said resistive touch input component.

5. The device of claim 3, wherein
said device is further configured to provide a direct voltage at said at least one second terminal, and
wherein said device is further configured to determine a direct current between said at least first and second terminals, and wherein said device is further configured to determine a position of an input on the touch input component.

6. The device of claim 2, wherein said device is further configured to determine a change of the impedance of at least one first terminal.

7. The device of claim 6, wherein said device is further configured to provide a changing voltage to said at least one first terminal, and to determine said change on the impedance of said at least one first terminal by determining a change of changing current caused by said changing voltage applied to said at least one first terminal.

8. The device of claim 2, wherein said device is further configured to determine a change of the impedance of at least one second terminal.

9. The device of claim 8, wherein said device is further configured to provide a changing voltage to said at least one second terminal, and to determine said change on the impedance of said at least one first terminal by determining a change of changing current caused by said changing voltage applied to said at least one second terminal.

10. The device of claim 2, wherein said device is further provided with a proximity output, and wherein said device is configured to output a proximity signal if and when a change of impedance of at least one of the first or second terminals has been detected.

11. The device of claim 10, wherein said device is further provided with a storage to store a “no proximity value” for said impedance, and wherein said proximity signal is outputted if and when a difference between said stored “no proximity value” impedance and said determined impedance exceeds a predetermined threshold.

12. The device of claim 11, wherein said device is further configured to stop providing said direct current voltage to said at least one of the first and second terminals when a difference between said stored “no proximity value” impedance and said determined impedance does not exceed a predetermined threshold.

13. The device of claim 5, wherein said device is further configured to stop applying said changing voltage if a direct current is detected between said at least first and second terminals.

14. The device of claim 3, further comprising an electronic device having a touch input component and at least a processing unit connected to said device and said touch input component.

15. The device of claim 14, wherein said electronic device comprises a PDA, handheld gaming device, camera, GPS or navigation device, a media player or a cellular telephone.

16. A method for operating a device for controlling a resistive touch input component, said method comprising:
providing at least a first terminal of said device for connecting an upper conductive layer of said resistive touch input component in a high impedance state, and
providing each of at least one second terminal for connecting a lower conductive layer of said resistive touch input component in a state capable of operating said touch input component.

17. The method of claim 16,
wherein said device further comprises a resistive touch input component, having at least one upper conductive layer and at least one lower conductive layer,
wherein at least one first terminal is connected to an upper conductive layer of said resistive touch input component and,
wherein at least one second terminal is connected to a lower conductive layer of said resistive touch input component, and
wherein said providing at least a first terminal in a high impedance state, comprises providing said at least one connected upper layer in a high impedance state, and
wherein said providing at least a second terminal in a high impedance state comprises providing said at least one connected lower layer in a high impedance state.

18. The method of claim 16, said method comprising
providing a direct voltage at said at least one second terminal, and
if at least one direct current between said at least one first and second terminals is detected:
determining a position of a touch input on a touch input component on the basis of said detected direct current.

19. The method of claim 16, further comprising
sensing the impedance of at least one first terminal, and
if a change in the impedance of at least one first terminal is sensed:
outputting a proximity signal.

20. The method of claim 19, wherein
said sensing the impedance of at least one first terminal comprises:
providing a changing voltage to at least one first terminal, and
determining a change of changing current caused by said changing voltage applied to said at least one first terminal.

21. The method of claim 20, further comprising
sensing the impedance of at least one second terminal.

22. The method of claim 21, wherein
said sensing the impedance of at least one second terminal comprises:
providing a changing voltage to at least one second terminal, and
determining a change of changing current caused by said changing voltage applied to said at least one second terminal.

23. The method of claim 19, further comprising
sensing and storing a “no proximity” impedance value,
wherein said proximity signal is outputted if and when a difference between said stored “no proximity” impedance value and said determined impedance exceeds a predetermined threshold.

24. The method of claim 23, further comprising
stop providing said direct current voltage to said at least of the one first and second terminals when a difference between said stored “no proximity value” impedance and said determined impedance does not exceed a predetermined threshold.

25. The method of claim 23, further comprising
stop applying said changing voltage if a direct current is detected between said at least one first and second terminals.

26. The method of claim 23, in an electronic device having a device for a resistive touch input component, said method further comprising
changing the settings of said electronic device in dependence if the device for a resistive touch input component outputs a proximity signal or not.

27. Computer program product configured to operate an device for a resistive touch input component, comprising program code sections for carrying out the steps of claim 16, when said program is run on a device, processor-based device, a computer, a microprocessor based device, a terminal, a network device, a mobile terminal or a mobile communication enabled terminal.

28. Computer program product for executing a method configured to operate a device for a resistive touch input component, comprising program code sections stored on a machine-readable medium for carrying out the steps of claim 16, when said program product is run on a device, processor-based device, a computer, a microprocessor based device, a terminal, a network device, a mobile terminal, or a mobile communication enabled terminal.

29. A device, comprising,
a resistive touch input means,
wherein said resistive touch input means comprises an upper conductive means and a lower conductive means, and
said upper conductive means is in a higher impedance state than said lower conductive means.

30. A device for a resistive touch input component, comprising,
at least one first means for connecting an upper conductive layer of a resistive touch input component and,
at least one second means for connecting a lower conductive layer of a resistive touch input component,
wherein said device comprises means for providing said at least one first means for connecting in a high impedance state with respect to said second means for connecting.
